(19) United States
(12) Patent Application Publication
(10) Pub. No.: US 2003/0020023 A1
(43) Pub. Date: Jan. 30, 2003

(54) Catalyze lamp set used in an air conditioning device

(76) Inventor: Yuan-Huan Lee, Hsin Chu Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/910,890

(22) Filed: Jul. 24, 2001

(51) Int. Cl. H01S 3/22

(52) U.S. Cl. 250/492.1

(57) ABSTRACT

A catalyze lamp set used in an air conditioning device has a frame. At least one optic catalyzer air cleaning lamp tube is connected to the frame. A glass fiber sleeve having an optic catalyzer film encloses the lamp tube. The lamp tube is pivotally connected to a vent of the air condition.

### FIELD OF THE INVENTION

The present invention relates to a catalyze lamp set used in an air conditioning device, and particularly to a modularized air processing device which can be conveniently connected to the air inlet or the air outlet of any air conditioner.

### BACKGROUND OF THE INVENTION

In a prior art design, light steel frames are installed at the ceiling and then some decorating plates are installed along the frame. The lamps are then installed on the plates. Furthermore, air conditioners are further installed. Moreover, a wind exhauster or a wind absorber is installed on the ceiling so as to provide a circulation function to an air conditioner. Since the installing position of the air exhauster and air absorber is not preferred; the outlook is destroyed and air can not be exhausted uniformly. Dusts float in the air so as to pollute some business machines or furniture, such as computers, beds, etc. Moreover, it is harmful to human bodies.

A prior art top absorbing type illuminator or wind opening having a function of cleaning is illustrated, as shown in FIG. 1. In the design, an illuminator 11 and a corresponding lampshade 12 are installed. A three tube structure is shown in the figure. The middle lampshade is connected to a fixing plate 14 extending from an inner shade 13. The shades at two sides are connected to the inner shade 13 through a cross plate 15. A gap is formed between the two lateral shades and the middle shades, thereby, air may flow through the gap. The cross plate 15 is installed with a though hole. Air may flow through the though hole to enter into the inner shade 13. An electronic dust collecting net 16 is installed above the illuminator 11, i.e., the inner side of the inner shade. An electric static generator generates an electronic static high pressure so that the net 16 and a porous conductive carbon structure will be charged for absorbing polluted objects in the air. Then filtered air is exhausted from an opening at a top of the inner shade 13, and then through a channel in an outer shade 17 placed out of the inner shade 13. The air is driven by a fan, thereby, indoor air will flow through the net and then is sent back or to an air conditioner.

The prior art structure has a defect is that the whole height is several times of a lamp and thus a large space is necessary. The dust collecting net needs extra power source. Further, the collected dusts must be cleaned, otherwise the net will lose its function, and moreover, the collected dusts will vent out from the outer shade. This is because no updating mean is installed.

### SUMMARY OF THE INVENTION

Accordingly, the primary object of the present invention is to provide a catalyze lamp set used in an air conditioning device, wherein a plurality of optic catalyzer air cleaning lamp tubes are positioned to a frame so as to be formed as an easily assembled module. Two lateral sides of this module are communicated, thereby, matching various shapes of various air conditioners. The modules can be directly supplied to various manufacturer and then are installed with panels. Besides, the same module is suitable for various air conditioner. It is only necessary to install the module of the present invention to proper positions of an air conditioner, thereby, the effect of cleaning air being achieved.

To achieve the objects, the present invention provides a catalyze lamp set used in an air conditioning device. The catalyze lamp set has a frame. At least one optic catalyzer air cleaning lamp tube is connected in the frame. A glass fiber sleeve having an optic catalyzer film encloses the lamp tube. The lamp tube is connected to a lamp tube with glass fibre sleeve or is pivotally connected to a vent of the air condition.

The various objects and advantages of the present invention will be more readily understood from the following detailed description when read in conjunction with the appended drawing.

### BRIEF DESCRIPTION OF THE DRAWINGS

FIG. 1 is a cross sectional view of a prior art design.

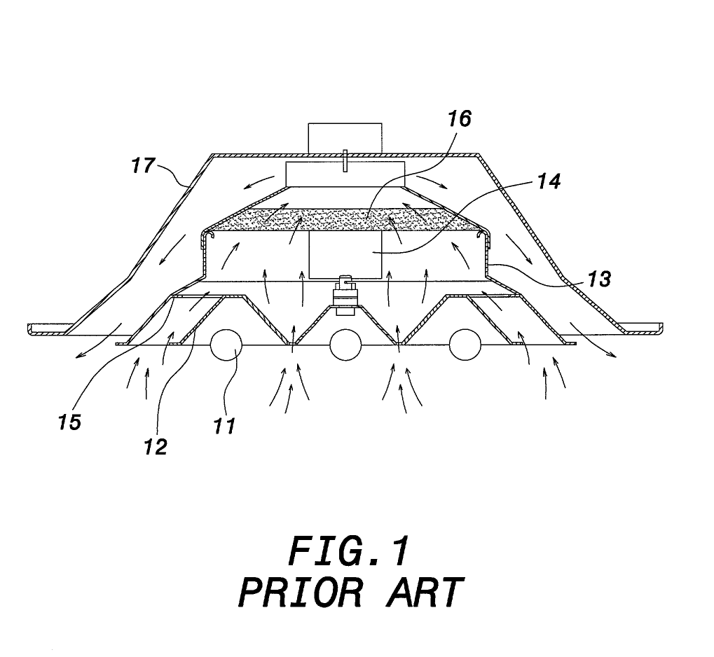

FIG. 2 is a perspective view of the present invention.

FIG. 3 is an exploded perspective view of the first embodiment in the present invention.

FIG. 4 is an exploded perspective view of the second embodiment in the present invention.

### DETAILED DESCRIPTION OF THE PREFERRED EMBODIMENTS

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

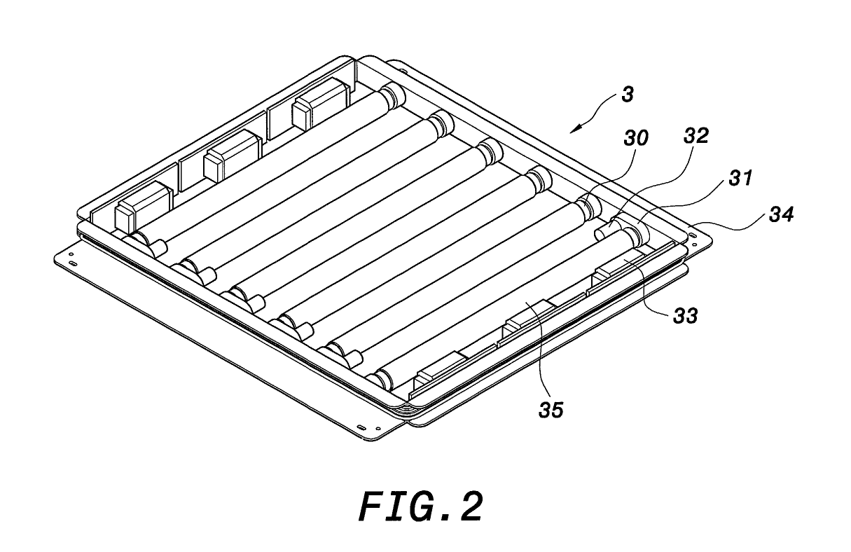

Referring to FIG. 2, the catalyze lamp set used in an air conditioning device of the present invention is illustrated. The catalyze lamp set used in an air conditioning device has a frame 3 which is connected to at least one optic catalyzer air cleaning lamp tube 30. A glass fiber sleeve of optic catalyzer film encloses the frame 3. Each lamp tube 30 of the present invention has two ends connected to a seat 31. The seat 31 has a starter 32 and is connected to a ballast 33. Two outer sides of the frame 3 are connected to a fixing plate 34, thereby, the frame 3 can be fixed to a proper position. In general, the fixing plate 34 of the frame 3 is locked to a respective jointing position.

In the present invention, the optic catalyzer air cleaning lamp tube is an ultraviolet sterilizing lamp tube which emits ultraviolet lamp tube for sterilization, or is an air cleaning waste gas processing lamp tube which emits a special light with wavelength beneficial for cleaning air.

Above optic catalyzer air cleaning lamp tube has filed a patent, Taiwan Patent No. 87113380, “Ultraviolet Lamp Tube for Processing a Waste Gas”. In that, the way for manufacturing a lamp tube is described.

The lamp tube is a particle-like glue of Anatase titanium dioxide by gluing technology. The Anatase titanium dioxide is semiconductor material. As ultraviolet light radiates to the Anatase titanium dioxide, it will generate electron-hole pair. The electrons-hole pair generates hydroxyl free redicals with the oxygen and vapor in the water may oxidize and decompose organic waste gas in air, thereby, reducing inorganic waste in the air so as to generate harmless carbon dioxide and water.

In embodiment, the waster gas process is safer than ozone, is economic than active carbon. The hydroxide free radicals on the optic catalyzer have effects of sterilization. Therefore, it is better than HEPA which only suppresses the generation of germ but not sterilize, better than the electronic static dust collector which does not decompose chemical compounds and not sterilize, better than ozone which is harmful to human bodies. In the present invention, ultraviolet lamp tubes are used to enclose the optic catalyzer glass fiber. The effect of sterilization remains and furthermore, waste gas is processed so that floating particles can be decomposed. The optic catalyzer fiber cloth has the effect of filtering. The ultraviolet ray and optic catalyzer may decompose organic particles and sterilize so as to retain a clean filtering cloth.

In the present invention, if the lamp tubes can not light up, it is only necessary to open the frame for updating the lamp tube. Therefore, the maintenance work is convenient. Moreover, after radiating for a long time by the fiber tube, the absorbed oil, dust and germs can be decomposed and removed through the function of the optic catalyzer. Therefore, dusts will not accumulate on the lamp tubes. Therefore, the present invention has the function of collecting dust, sterilization, suppressing generation of germs, and cleaning. Furthermore, the present invention generates free radicals to decompose waste gas for protecting the quality of air.

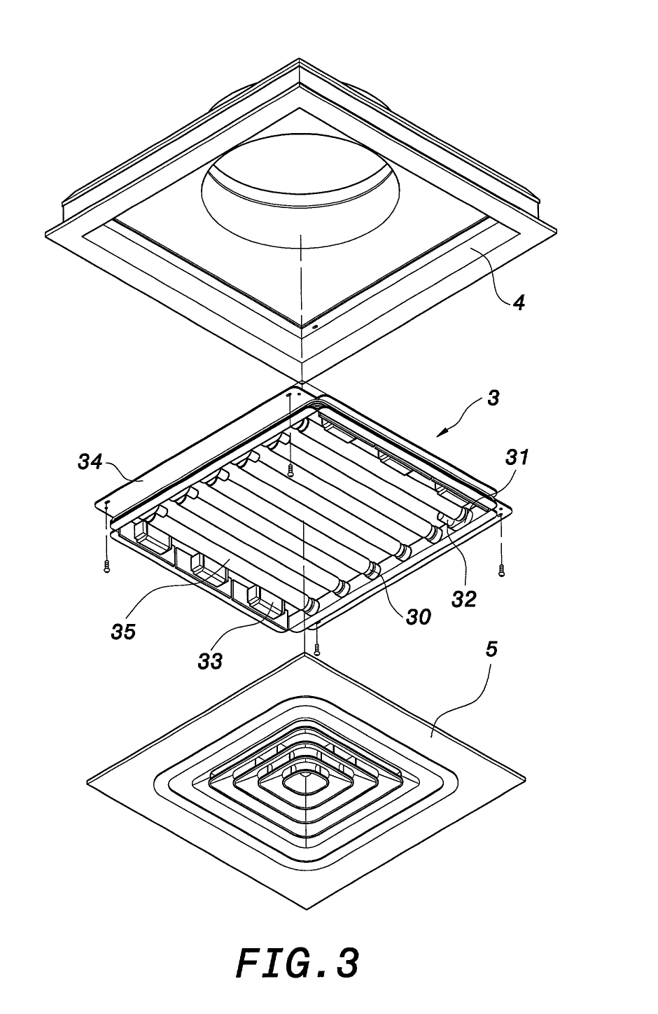

Moreover, as shown in FIG. 3, the frame 3 of the present invention is assembled to an outer side of a ventilator 4, and a guide plate 5 is adhered to an outer surface thereof. Namely, the air outlet is added with the function of the present invention for processing air, that is, the present invention can be installed to the air inlets and air outlets of ventilators of an air conditioning device.

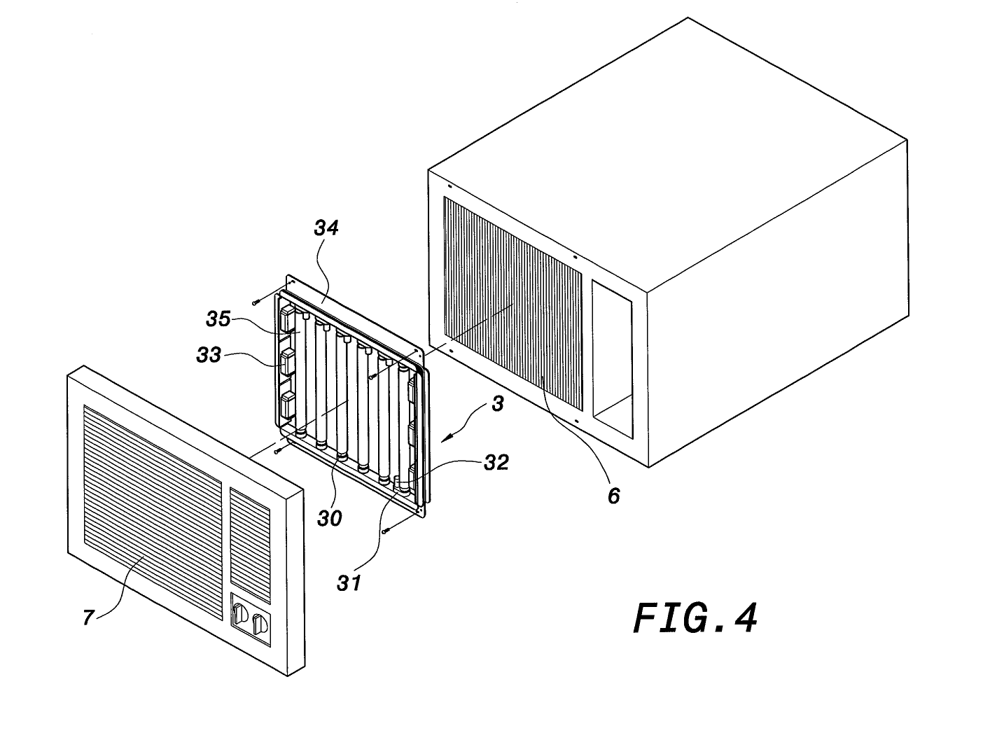

Furthermore, as shown in FIG. 4, the frame 3 of the present invention is assembled to the interior of the panel 7 of a box type air conditioner 6. Then, it has the function better than the prior art. Thus, the present invention can be installed at the air inlet and air outlet of an air conditioning device. Furthermore, the present invention can be applied to the master and slave air conditioner of a separable air conditioner. Moreover, the present invention can be used to a large refrigerator.

From above description, it is appreciated that in the present invention, a modularized design is used to form a simple structure. Thereby, it can be used to the air inlets and air outlets of various air conditioning device. The present invention is completely different from the prior art design.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A catalyze lamp set used in an air conditioning device comprising:
a frame connected to at least one optic catalyzer air cleaning lamp tube;
a glass fiber sleeve having an optic catalyzer film enclosing the lamp tube; the lamp tube being pivotally connected to a vent of the air condition.

2. The catalyze lamp set used in an air conditioning device as claimed in claim 1, wherein the air conditioning device is a ventilator or an air conditioner.
